(19) United States
(12) Patent Application Publication
(10) Pub. No.: US 2007/0256018 A1
(43) Pub. Date: Nov. 1, 2007

(54) Content Providing System

(76) Inventors: Masayuki Chatani, Tokyo (JP); Hirotoshi Maegawa, Tokyo (JP); Shigeru Sugimoto, Tokyo (JP); Takeshi Hashimoto, Tokyo (JP); Hideaki Okamura, Tokyo (JP)

Correspondence Address: William S. Frommer;Frommer Lawrence & Haug, 745 Fifth Avenue, New York, NY, 10151, US

(21) Appl. No.: 11/579,986

(22) PCT Filed: May 10, 2005
(86) PCT No.: PCT/JP05/08543

§ 371 Date: Jun. 26, 2007

(30) Foreign Application Priority Data
May 10, 2004 (JP) 2004-169252
Nov. 8, 2004 (JP) 2004-354648

(51) Int. Cl. G06F 3/00

(52) U.S. Cl. 715/733

(57) ABSTRACT

A content providing system is provided that can promptly produce and provide content for a plurality of different media by facilitating mutual sharing of material data.

A content production and output support apparatus (14) comprises a material data storing section (30) for storing material data that is created by a material data creating section (26), a script data storing section (32) for storing script data that is created by a script data creating section (28), and a content data generating section (34) for generating content data in a form corresponding to a medium specified by a user based on the script data identified by the user and the material data identified by the material identifying data in the script data.

### TECHNICAL FIELD

The present invention relates to a content providing system, a method and apparatus for producing content, a method and apparatus for outputting content, a supporting method and apparatus for outputting content, and a computer readable information storage medium.

### BACKGROUND ART

Conventionally, content that is provided via various media such as games, films, and broadcasting is independently produced using separate systems, even if the content has a common theme. That is, for example, when game content or broadcast content that have a common work theme with film content are produced, separate systems that are different from that which was used for the production of the film content are prepared to be used for the production of new content.

However, the conventional approach has a problem in that the material data, such as dynamic image data, static image data, or voice data that are required in producing content cannot be mutually shared, resulting in wasteful production processing. If it is intended from the outset to provide content for a common work theme via a plurality of different media, a total speed-up of the production of the content by the facilitation of mutual sharing between the material data is desirable.

The present invention was made in view of the above problem, and one object of the present invention is to provide a content providing system, a method and apparatus for producing content, a method and apparatus for outputting content, a supporting method and apparatus for outputting content, and a computer readable information storage medium that are capable of quickly producing and providing content for a plurality of different media by facilitating mutual sharing between material data.

### DISCLOSURE OF THE INVENTION

In order to solve the above problem, a content providing system according to the present invention comprises a content production apparatus and a content output apparatus that are connected in communication with each other via a data communication network.

The content production apparatus comprises: material data creating means for creating one or a plurality of material data that individually comprise at least one of dynamic image data, static image data, and voice data; material data storing means for storing the created material data; script data creating means for creating script data including one or a plurality of material identifying data that individually identifies either one of or a plurality of material data; script data storing means for storing the created script data; and content data generating means for generating content data in a form that corresponds to the media specified by a user based on the script data identified by the user and the material data identified by the material identifying data in the script data.

Meanwhile, the content output apparatus comprises: content data obtaining means for obtaining the content data that is generated by the content data generating means; and an outputting means for outputting content in a predetermined way based on the obtained content data.

A method for producing content according to the present invention comprises: a material data creating step for creating one or a plurality of material data that individually includes at least one of dynamic image data, static image data, and voice data; a script data creating step for creating script data including one or a plurality of material identifying data that individually identifies either one or a plurality of material data; a script data identifying step for identifying the script data; and a content data generating step for generating content data in a form that corresponds to the media specified by a user based on the identified script data and the material data identified by the material identifying data in the script data.

A content production apparatus according to the present invention comprises: material data storing means for storing one or a plurality of material data that individually includes at least one of dynamic image data, static image data, and voice data; script data storing means for storing script data including one or a plurality of material identifying data which individually identifies either one or a plurality of material data; and a content data generating means for generating content data in a form that corresponds to the media specified by a user based on the script data identified by the user and the material data identified by the material identifying data in the script data.

A computer readable information storage medium according to the present invention is a computer readable information storage medium that stores a program that enables various computers to function as: material data storing means for storing one or a plurality of material data which individually includes at least one of dynamic image data, static image data, and voice data; script data storing means for storing script data including one or a plurality of material identifying data that individually identifies either one or a plurality of material data; and a content data generating means for generating content data in a form that corresponds to a media specified by a user based on the script data identified by the user and the material data identified by the material identifying data in the script data.

In the present invention, in a content production apparatus, one or a plurality of material data that individually includes at least one of dynamic image data, static image data, and voice data is created. In addition, script data including one or a plurality of material identifying data that individually identifies either one or a plurality of material is created. When script data is identified by a user or the like, content data is generated based on the script data and material data identified by material identifying data in the script data. In the generation, the content data is in a form that is specified by the user and that corresponds to a medium. The term “media” as used herein means a form that is used to provide content by replaying content data, and includes games, films, broadcasts, and the like.

The content output apparatus obtains content data that is generated by the content production apparatus via a data communication network or various information storage media, for example. Then, the content output apparatus outputs content in a predetermined way based on the obtained content data.

According to the present invention, when the content production apparatus creates material data and script data, content data for various media can be generated by using the material data and the script data, which facilitates a mutual sharing of the material data, resulting in content for a plurality of different media that can be quickly produced and provided.

In one aspect of the present invention, the content data generating means may comprise means for storing form data that indicates the form for content data corresponding to each medium, so that the content data generating means can read out the form data that corresponds to a medium specified by the user from the storing means to generate content data in the form presented by the form data. This allows content data to be generated in a form corresponding to each medium without fail. In addition, this eliminates the extra effort to specify a data form in detail.

In one aspect of the present invention, the content data generating means generates content data that includes external supply data identifying data that identifies the external supply data, and the content production apparatus further comprises external supply data identifying data receiving means for receiving the external supply data identifying data from the content output apparatus via the data communication network, as well as an external supply data returning means for returning the external supply data identified by the received external supply data identifying data to the content output apparatus via the data communication network, and the content output apparatus further comprises an external supply data identifying data transmitting means for transmitting the external supply data identifying data in the obtained content data to the content production apparatus via the data communication network, and an external supply data receiving means for receiving the external supply data that is returned from the content production apparatus via the data communication network, and the outputting means outputs content in a predetermined way based on the obtained content data and the received external supply data.

According to this aspect, content data including the external supply data identifying data that identifies the external supply data is generated. The term “external supply data” as used herein means data that should be supplied from the external to the content output apparatus when content is output in a predetermined way based on the content data.

The content output apparatus, after obtaining content data generated at the content production apparatus, transmits the external supply data identifying data that is included in the content data to the content production apparatus via a data communication network. The content production apparatus receives the external supply data identifying data, and returns the external supply data that is identified by the external supply data identifying data to the content output apparatus.

At this point, the external supply data that is identified by the external supply data identifying data may be generated based on the material data stored in the material data storing means. For example, the external supply data identifying data is provided with data for instructing a medium, so that the external supply data can be generated by converting the material data stored in the material data storing means into a form that corresponds to the medium instructed by the data.

The content output apparatus receives the external supply data from the content production apparatus, and outputs content in a predetermined way based on the external supply data and the obtained content data.

According to this aspect, because content is output in a predetermined way using the external supply data that is transmitted from the content production apparatus, the content of the output can be easily updated, and fresh content can be provided to a user.

In the script data creating step, when the script data is created, time attribute data that indicates the date and time when the script data is created may be further created in association with the script data, and in the script data identifying step, when the time attribute data is specified, the script data that is associated with the specified time attribute data may be identified. This allows the content data to be generated based on the script data that is created at any point in time.

In the material data creating step, when each material data is created, time attribute data that indicates the date and time when the material data is created may be further created in association with the material data, and in the content data generating step, content data may be generated in a predetermined form based on the identified script data and the material data associated with the given time attribute data among the material data identified by the material identifying data in the script data. This allows content data to be generated based on material data that is created at any point in time.

In the content data generating step, at least one of the identified script data and the material data identified by the material identifying data in the script data may be received via a data communication network. This allows content data to be generated using data that is located at a remote site.

In the content data-generating step, generated content data may be transmitted via a data communication network. This allows the content data to be promptly used at a remote site.

A part or the whole of one or a plurality of material identifying data in the script data and the material identifying data for identifying other material data associated with the material data that is identified by the material identifying data are stored in a dependency storing means in advance in relation to each other, so that the method for producing content may further comprises an informing step for informing a user of the material data identified by the material identifying data that is stored in the dependency storing means in relation to the material identifying data when the material data identified by the material identifying data in the script data is newly created or updated. This allows a user, when the material data is newly created or updated, to know what other material data is associated with the material data.

A part or the whole of one or a plurality of material identifying data in the script data and the material identifying data for identifying other material data associated with the material data that is identified by the material identifying data are stored in a dependency storing means in advance in relation to each other, and also the e-mail address of the person in charge of the creation of each of the material data is stored in a person involved data storing means in advance, and the method for producing content may further comprise a step for reading out the e-mail address of the person in charge of the creation of the material data identified by the material identifying data, which is stored in the dependency storing means in relation to the material identifying data, from the person involved data storing means, and transmitting information on the new creation or updates of the material identifying data in the script data to the e-mail address when the material data identified by the material identifying data in the script data is newly created or updated. This allows the person in charge of the creation of other material data in association with the material data to know when material data is newly created or updated. As a result, the new creation or updating of other associated material data can be promptly undertaken.

A method for outputting content according to the present invention comprises: a content data obtaining step for obtaining content data that includes external supply data identifying data for identifying the external supply data: an external supply data receiving step for receiving the external supply data identified by the external supply data identifying data in the obtained content data via a data communication network; and an outputting step for outputting content in a predetermined way based on the obtained content data and the received external supply data.

An output supporting method according to the present invention comprises: an external supply data identifying data receiving step for receiving external supply data identifying data that is included in the content data via a data communication network; and an external supply data returning step for returning external supply data that is identified by the received external supply data identifying data via the data communication network.

A content output apparatus according to the present invention comprises: a content data obtaining means for obtaining content data that includes external supply data identifying data for identifying external supply data; external supply data receiving means for receiving the external supply data identified by the external supply data identifying data that is included in the obtained content data via a data communication network; and an outputting means for outputting content in a predetermined way based on the obtained content data and the received external supply data.

A content output supporting device according to the present invention comprises: an external supply data identifying data receiving means for receiving external supply data identifying data that is included in content data via a data communication network; and an external supply data returning means for returning external supply data that is identified by the received external supply data identifying data via the data communication network.

A computer readable information storage medium according to the present invention is a computer readable information storage medium that stores a program that enables various computers to function as: content data obtaining means for obtaining content data that includes external supply data identifying data for identifying external supply data; an external supply data receiving means for receiving the external supply data identified by the external supply data identifying data that is included in the obtained content data via a data communication network; and outputting means for outputting content in a predetermined way based on the obtained content data and the received external supply data.

A computer readable information storage medium according to the present invention is a computer readable information storage medium that stores a program that enables various computers to function as: an external supply data identifying data receiving means for receiving external supply data identifying data that is included in content data via a data communication network; and an external supply data returning means for returning external supply data that is identified by the received external supply data identifying data via the data communication network.

According to the present invention, because content is output in a predetermined way using external supply data that is transmitted from a content production apparatus, the content of the output can be easily updated, and fresh content can be provided to a user.

A method for producing content according to the present invention comprises: a material data creating step for creating one or a plurality of material data that individually includes at least one of dynamic image data, static image data, and voice data; a script data creating step for creating script data including one or a plurality of material identifying data that individually identifies either one or a plurality of material; a script data identifying step for identifying the script data; and a content data generating step for generating content data based on the identified script data and the material data that is identified by the material identifying data in the script data, with a part or the whole of the one or a plurality of material identifying data in the script data and the material identifying data for identifying other material data associated with the material data that is identified by the material identifying data being stored in a dependency storing means in advance in relation to each other, and the method for producing content further comprises an informing step for informing a user of the material data identified by the material identifying data that is stored in the dependency storing means in relation to the material identifying data when the material data identified by the material identifying data in the script data is newly created or updated.

A content production apparatus according to the present invention is a content production supporting device used in a system that uses one or a plurality of material data that individually includes at least one of dynamic image data, static image data, and voice data, and script data including one or a plurality of material identifying data that individually identifies either one or a plurality of material, and includes: a dependency storing means for storing a part or the whole of the one or a plurality of material identifying data in the script data and the material identifying data for identifying other material data associated with the material data that is identified by the material identifying data in relation to each other; and means for informing a user of the material data identified by the material identifying data that is stored in the dependency storing means in relation to the material identifying data when the material data identified by the material identifying data in the script data is newly created or updated.

A computer readable information storage medium according to the present invention is a computer readable information storage medium that stores a program for enabling a computer to function as a content production supporting device used in a system that uses one or a plurality of material data that individually includes at least one of dynamic image data, static image data, and voice data, and script data including one or a plurality of material identifying data that individually identifies either one or a plurality of material, a program enabling the computer to function as: a dependency storing means for storing a part or the whole of one or a plurality of material identifying data in the script data and the material identifying data for identifying other material data associated with the material data that is identified by the material identifying data in relation to each other; and means for informing a user of the material data identified by the material identifying data that is stored in the dependency storing means in relation to the material identifying data when the material data identified by the material identifying data in the script data is newly created or updated.

According to the present invention, when material data is newly created or updated, a user can be informed of other material data associated with the material data.

A method for producing content according to the present invention comprises: a material data creating step for creating one or a plurality of material data that individually includes at least one of dynamic image data, static image data, and voice data; a script data creating step for creating script data including one or a plurality of material identifying data that individually identifies either one or a plurality of material; a script data identifying step for identifying the script data; and a content data generating step for generating content data based on the identified script data and the material data that is identified by the material identifying data in the script data, with a part or the whole of one or a plurality of material identifying data in the script data and the material identifying data for identifying other material data associated with the material data that is identified by the material identifying data being stored in a dependency storing means in advance in relation to each other, and also the e-mail address of the person in charge of the creation of each of the material data being stored in a person involved data storing means in advance, and a method for producing content further comprises a step for reading out the e-mail address of the person in charge of the creation of the material data identified by the material identifying data, which is stored in the dependency storing means in relation to the material identifying data, from the person involved data storing means, and transmitting information on the new creation or update of the material identifying data in the script data to the e-mail address when the material data identified by the material identifying data in the script data is newly created or updated.

A content production apparatus according to the present invention is a content production supporting device used in a system which uses one or a plurality of material data that individually includes at least one of dynamic image data, static image data, and voice data, and script data including one or a plurality of material identifying data that individually identifies either one or a plurality of material, and the content production apparatus comprises: dependency storing means for storing a part or the whole of the one or a plurality of material identifying data in the script data and the material identifying data for identifying other material data associated with the material data which is identified by the material identifying data in relation to each other; person involved data storing means for storing the e-mail address of the person in charge of the creation of each of the material data; and means for reading out the e-mail address of the person in charge of the creation of the material data identified by the material identifying data, which is stored in the dependency storing means in relation to the material identifying data, from the person involved data storing means, and transmitting information on the new creation or update of the material identifying data in the script data to the e-mail address when the material data identified by the material identifying data in the script data is newly created or updated when the material data identified by the material identifying data in the script data is newly created or updated.

A computer readable information storage medium according to the present invention is a computer readable information storage medium which stores a program for enabling a computer to function as a content production supporting device used in a system that uses one or a plurality of material data that individually includes at least one of dynamic image data, static image data, and voice data, and script data including one or a plurality of material identifying data that individually identifies either one or a plurality of material, the program enabling a computer to function as: dependency storing means for storing a part or the whole of the one or a plurality of material identifying data in the script data and the material identifying data for identifying other material data associated with the material data which is identified by the material identifying data in relation to each other; person involved data storing means for storing the e-mail address of the person in charge of the creation of each of the material data; and means for reading out the e-mail address of the person in charge of the creation of the material data identified by the material identifying data, which is stored in the dependency storing means in relation to the material identifying data, from the person involved data storing means, and transmitting information on the new creation or update of the material identifying data in the script data to the e-mail address when the material data identified by the material identifying data in the script data is newly created or updated when the material data identified by the material identifying data in the script data is newly created or updated.

According to the present invention, when material data is newly created or updated, the person in charge of the creation of other material data associated with the material data can be informed of the new creation or update of the material data. As a result, a new creation or update of other associated material data can be promptly started.

### BRIEF DESCRIPTION OF THE DRAWINGS

FIG. 1 is a conceptual diagram showing a state in which content data is generated by an embodiment of the present invention;

FIG. 2 is a diagram showing an entire structure of an embodiment of a content providing system according to the present invention;

FIG. 3 is a diagram showing content stored in a material data storing section;

FIG. 4 is a diagram showing content of script data;

FIG. 5 is a diagram showing a relationship between script data and material data;

FIG. 6 is a diagram showing content stored in a script data storing section;

FIG. 7 is a diagram showing content of content data;

FIG. 8 is a diagram showing an entire structure of another embodiment of a content providing system according to the present invention;

FIG. 9 is a diagram showing content of script data according to another embodiment;

FIG. 10 is a diagram showing a presentation example of script data; and

FIG. 11 is a diagram showing a relationship between script data and material data.

### BEST MODE FOR CARRYING OUT THE INVENTION

Now, an embodiment of the present invention will be explained in detail below with reference to the accompanying drawings.

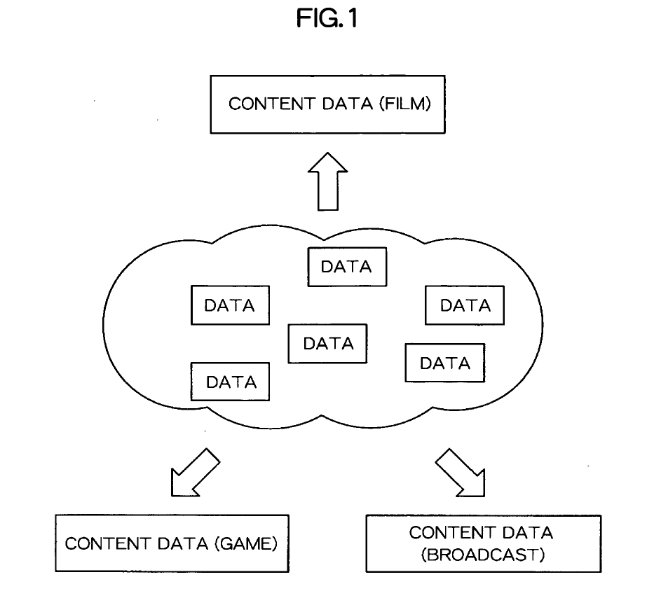

FIG. 1 is a conceptual diagram showing a state in which content data is generated by this embodiment. As shown in FIG. 1, according to this embodiment, various data which can be a source of a content data for a plurality of different types of media (herein, games, films, and broadcasting are given as examples) are created in advance. These data include various material data and script data.

Material data is, for example, dynamic image data for presenting dynamic images, static image data for presenting static images, voice data for presenting voices, or a combination of these data, and is directly or indirectly shared by one or a plurality of media. That is, one material data is sometimes not only included in a content data for one medium or used with the content data, but is sometimes included in a content data for another medium or used with the content data. In the latter case, the material data can be used in the original form, or can be used after being processed for various media.

Script data is data that represents a structure of content, and includes one or a plurality of material identifying data. Each of the material identifying data will identify material data that is to be used in content. In this embodiment, a part or the whole of the data is used to generate a content data for various media. In this way, in generating a content data for a plurality of different media, a mutual sharing of source data for content data is facilitated.

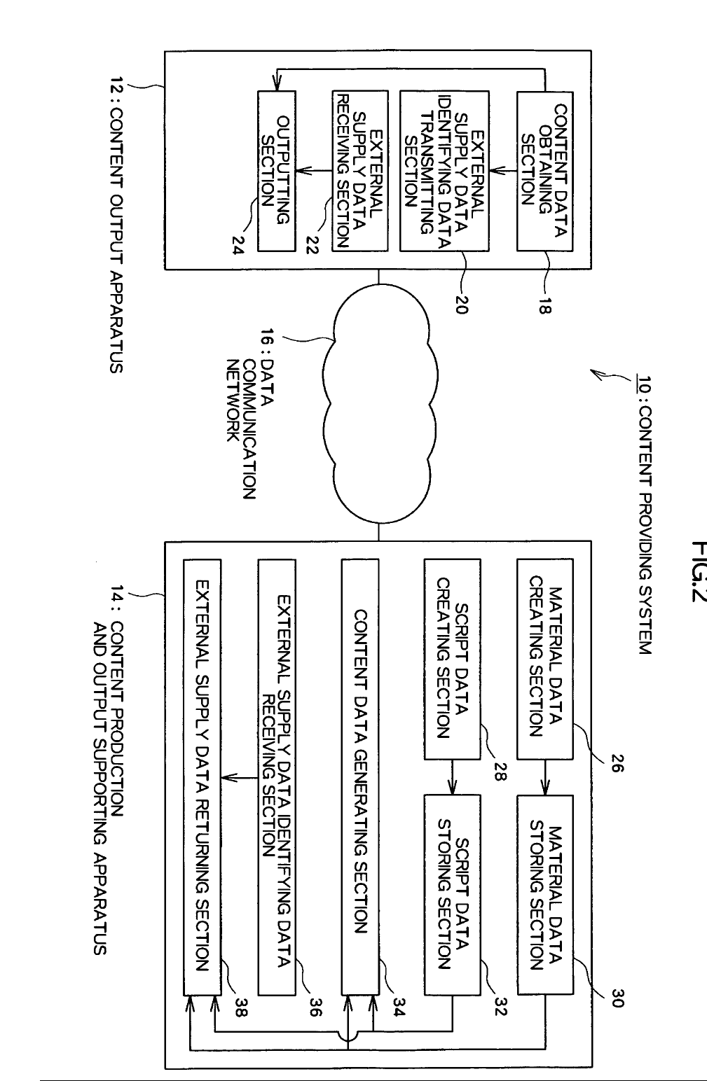

FIG. 2 is a diagram showing an entire structure of a content providing system according to the embodiment. As shown in FIG. 2, a content providing system 10 is configured to have a content output apparatus 12 and a content production and output support apparatus 14. Each of the content output apparatus 12 and the content production and output support apparatus 14 is mainly comprised of a computer, and are connected to each other via a data communication network 16 such as the Internet for mutual data communication. The content output apparatus 12 is, for example, a device that can replay content data for one or a plurality of media, and is comprised of a home-use game machine, the personal computer, a media player, a home server, a cell phone, the personal digital assistant, a complex machine having a combination of these, or the like.

The content production and output support apparatus 14 is configured with one or a plurality of computers, and is used to create material data and script data which will be a source of various content data, and to generate a content data therefrom. The content production and output support apparatus 14 is preferably a high performance computer such as a workstation. Since a plurality of producers (script producers, material producers, content producers, and the like) are involved in creating the material data and the script data, the content production and output support apparatus 14 may be connected to other computers via various data communication networks to create the material data and script data therefrom. Alternatively, the whole or a part of material data may be created in other computers to be supplied to the content production and output support apparatus 14 via the network. Similarly, the whole or a part of the script data may be created in other computers to be supplied to the content production and output support apparatus 14 via the network.

The content production and output support apparatus 14 of this embodiment comprises at least one CPU which is the same one for the content output apparatus 12 and data storing means (for example, a memory or a hard disk memory unit) which has a larger capacity than that of the content output apparatus 12, so that the content production and output support apparatus 14 can execute a program, which is also executed by the content output apparatus 12, at a higher speed (with a margin of memory or the like). This enables an examination on a condition of a program execution in the content output apparatus 12 to be performed in advance in the content production and output support apparatus 14.

Now functional structures of the content output apparatus 12 and the content production and output support apparatus 14 will be explained below in detail.

As shown in FIG. 2, the content production and output support apparatus 14 comprises a material data creating section 26, a material data storing section 30, a script data creating section 28, a script data storing section 32, a content data generating section 34, an external supply data identifying data receiving section, and an external supply data returning section 38. These components are achieved when a content production program and a content output assistant program are installed onto the content production and output support apparatus 14 that has a computer, and the programs are executed by the content production and output support apparatus 14.

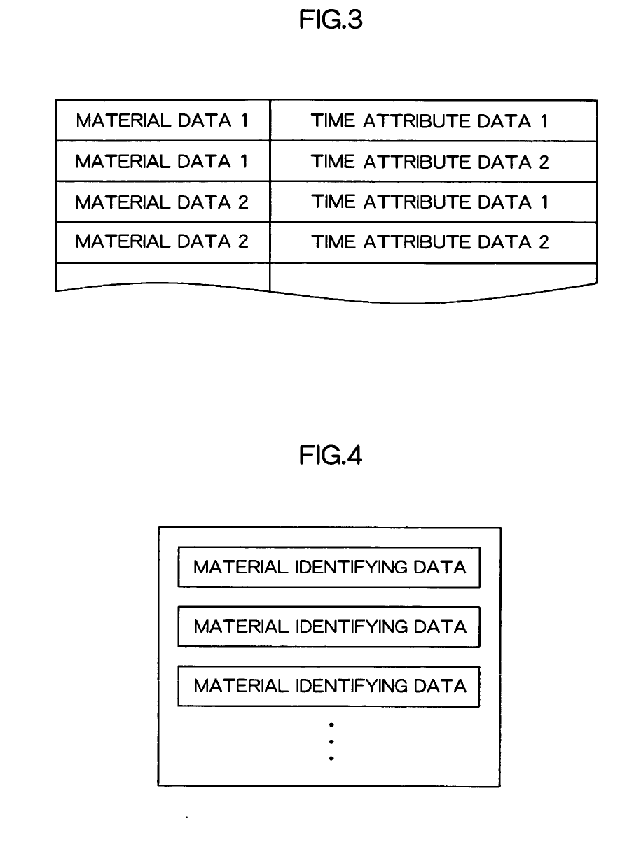

First, the material data creating section 26 creates one or a plurality of material data which individually includes at least one of dynamic image data, static image data, and voice data. The material data creating section 26 may create any combination of the dynamic image data, the static image data, or the voice data as material data. In addition, the material data creating section 26 may create data that identifies one or a plurality of material data as material data. The material data creating section 26 can be achieved, for example, by a known editing program for editing dynamic image data, static image data, voice data, or a combination of these. The material data storing section 30 stores the material data created by the material data creating section 26, and is configured, for example, with various storing means such as a hard disk storage device. When the material data creating section 26 creates material data and stores the material data in the material data storing section 30, the material data creating section 26 obtains data for the current date and time from a calendar provided in the content production and output support apparatus 14, and stores the data as time attribute data in association with the material data in the material data storing section 30. That is, the material data storing section 30, as shown in FIG. 3, stores material data and time attribute data that indicates a date and time when the material data was created, in association with each other. In this embodiment, data that indicates a date and time as time attribute data is used, but other data such as data that indicates a version number may be used. In addition, data (producer data) for identifying the person who was involved in the production (a script producer, a material producer, a content producer, and the like) may be stored in relation to each material data.

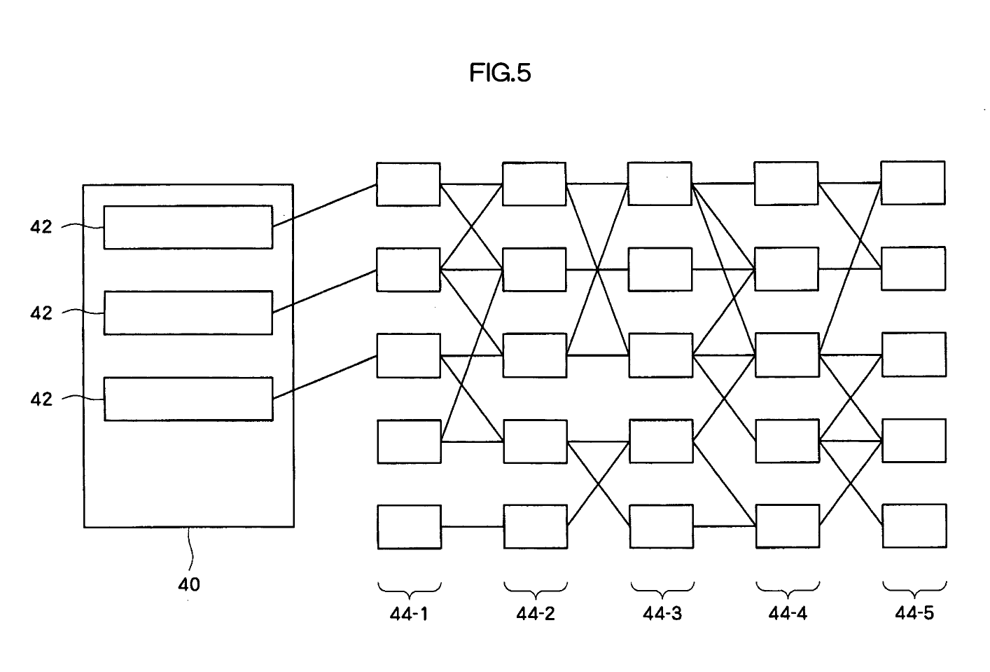

The script data creating section 28 creates script data including one or a plurality of material identifying data which individually identifies one or a plurality of material data. FIG. 4 schematically shows the content of script data that is created by the script data creating section 28. The material identifying data included in the script data does not have to identify only dynamic image data, static image data, or voice data, but may identify dynamic image data, static image data, voice data, or a combination of these (which are also material data). In this case, as shown in FIG. 5 (in which material data is classified into five groups (hierarchies)), script data 40 includes a plurality of material identifying data 42, and each of the material identifying data 42 identifies material data 44-1 which belongs to a first group. Each material data 44-1 of the first group identifies one or a plurality of material data 44-2 that belongs to a second group. Similarly, each material data 44-n that belongs to an nth group identifies one or a plurality of material data 44-(n+1) which belongs to (n+1)th group, where n=1, 2, 3, and 4.

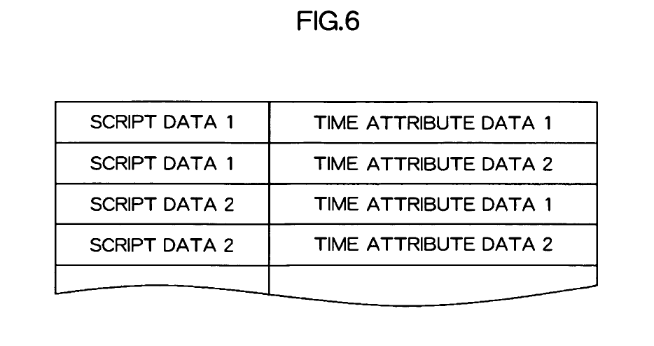

The script data creating section 28 can be achieved by a known editor program, for example. In this embodiment, the material identifying data includes a file name, and a path or necessary location information such as a network address of each material data, for example. The script data storing section 32 stores script data created by the script data creating section 28, and is configured with various storing means such as a hard disk storage device, for example. When the script data creating section 28 creates script data and stores the script data in the script data storing section 32, the script data creating section 28 obtains data for the current date and time from a calendar provided in the content production and output support apparatus 14, and stores the data as time attribute data in association with the script data in the script data storing section 32. That is, the script data storing section 32, as shown in FIG. 6, stores script data and time attribute data that indicate a date and time when the script data was created in association with each other. As in the case of material data, in this embodiment, data that indicates a date and time as time attribute data is used, but other data such as data that indicates a version number may be used. In addition, data (producer data) for identifying the person who is involved in the production (a script producer, a material producer, a content producer, and the like) may be stored in relation to each material data.

The content data generating section 34 generates content data based on one of the script data which is stored in the script data storing section 32 and specified by a user, and material data identified by material identifying data in the script data. In this generation, a part or the whole of material data may be obtained from another computer that is connected via a data communication network 16, instead of being obtained by reading out from the material data storing section 30 where the material data is stored. When a user is allowed to identify script data, data that is used to identify script data such as a file name of the script data and the like may be input by the user using inputting means such as a mouse or a key board. As described above, the script data storing section 32 stores time attribute data in association with each script data. So, for example, preferably time attribute data (time attribute data itself, or a condition data such as its range) is identified using inputting means such as a mouse or a key board, so that, among the script data stored in the script data storing section 32, script data which is associated with the identified time attribute data can be identified as base information to generate a content data. In addition, a condition for producer data may be specified, so that script data in association with producer data that satisfies the condition can be used. When time attribute data includes version information, after the version information is specified by a user, content data is generated based on script data in association with the version information, which facilitates generations of different versions of content. This allows different versions of content to be conveniently generated in a production processing, and the content can be easily compared, resulting in an enhanced effectiveness in producing content.

The script data, which is identified in this way, includes a material identifying data as described above, and the material identifying data identifies material data. In addition, the material data storing section 30 stores each material data in association with time attribute data. So, for example, preferably time attribute data (time attribute data itself, or a condition data such as its range) is identified using inputting means such as a mouse or a key board, so that, among the material data stored in the material data storing section 30, material data which is associated with the identified time attribute data can be identified as base information to generate a content data. In addition, a condition for producer data may be specified, so that material data in association with producer data that satisfies the condition can be used.

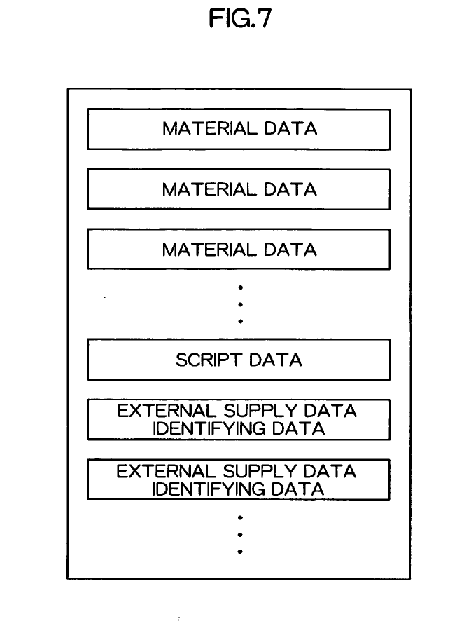

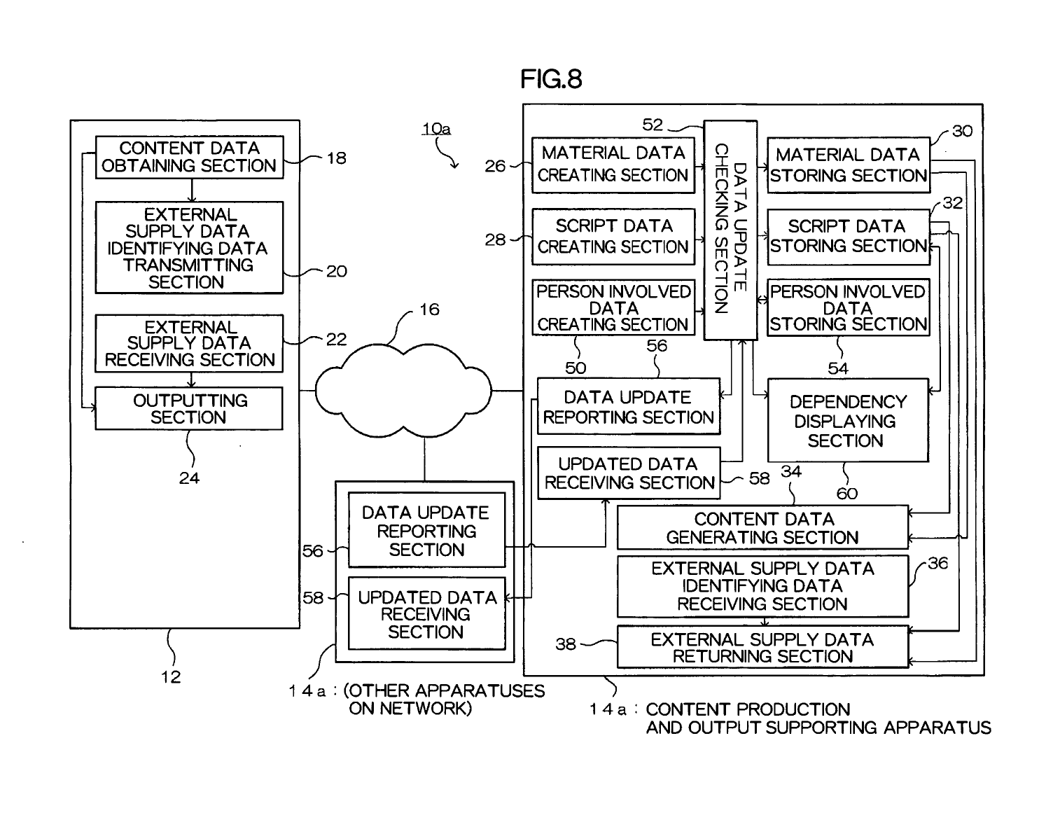

The content data is generated, as shown in FIG. 7, to include one or a plurality of material data, script data, and also external supply data identifying data which identifies external supply data. The external supply data is data that is necessary to generate content at the content output apparatus 12 based on content data, and is not stored in the content output apparatus 12 in advance, but is supplied from the content production and output support apparatus 14 every time it is required. The external supply data identifying data includes a file name and a network address of the external supply data, and a path to the external supply data.

In generation of content data, the content data can be generated for one of the media by identification. Thus, at the content production and output support apparatus 14, a user may be allowed to specify a medium for which content data is generated, or script data may have a record that shows a medium for which the script data is produced. Upon identification of a medium for which content data is generated, the content data is generated in a format (data form) corresponding to the medium. The term “media” as used herein means a providing form for providing content by replaying content data, and includes, for example, games (e.g., those provided by information storage media which are readable by various computers such as a DVD-ROM, those provided by a game server via a data communication network such as the Internet), films (e.g., those provided by information storage media which are generally distributed such as a DVD, those provided from a content server via various data communication networks on demand, or those provided in theater), and broadcasting (e.g., digital terrestrial broadcasting, CS digital broadcasting, or analog broadcasting). In this embodiment, after a medium is identified, a content data is generated in a form corresponding to the medium, but the form of a content data may be directly specified by a user.

Content data generated by the content data generating section 34 may be stored in a computer readable information storage medium such as a CD-ROM or a DVD-ROM to be distributed to a user of the content output apparatus 12. In this case, the content data stored in the information storage medium can be read out and replayed at the content output apparatus 12 to output content. Alternatively, the content data generating section 34 may transmit generated content to the content output apparatus 12 via the data communication network 16. In this case, the content output apparatus 12 receives the content data from the content production and output support apparatus 14 to replay the content data, so that content can be output.

When content data is replayed at the content output apparatus 12 to output content, external supply data identifying data in the content data is read out, and the external supply data identifying data is transmitted to the content production and output support apparatus 14 as a demand for external supply data.

When the external supply data identifying data which is transmitted from the content output apparatus 12 as described above is received at an external supply data identifying data receiving section 36, an external supply data returning section 38 obtains external supply data identified by the external supply data identifying data, and returns it to the content output apparatus 12. At this point, the external supply data returning section 38 reads out material data which is necessary to generate external supply data identified by the external supply data identifying data from the material data storing section 30. The external supply data identifying data may include, in advance, information on which material data should be read out. Script data that is necessary to generate external supply data is read out from the script data storing section 32 as needed. The external supply data returning section 38 then generates external supply data based on the material data and the script data that is read out as described above. In this case, the external supply data identifying data that is received from the content output apparatus 12 may include, in advance, information on a form in which external supply data should be generated. For example, when material data (dynamic image data or static image data) stored in the material data storing section 30 is used to generate external supply data which includes dynamic image data or static image data, if external supply data identifying data has information such as a resolution of the dynamic image data or the static image data which are to be included in the external supply data, the external supply data which will be used in the content output apparatus 12 can be generated without fail. Such external supply data generated as described above will be returned to the content output apparatus 12 from an external supply data returning section.

Meanwhile, the content output apparatus 12 is configured to include a content data obtaining section 18, an external supply data identifying data transmitting section 20, an external supply data receiving section 22, and an outputting section 24. These components are also achieved when a content output program is installed onto the content output apparatus 12 that has a computer, and the program is executed by the content output apparatus 12.

The content data obtaining section 18 obtains a content data generated by the content data generating section 34. As described above, the content data obtaining section 18 may obtain content data by reading out the content data stored in various information storage media, or obtain content data by receiving the content data via the data communication network 16. The external supply data identifying data transmitting section 20 transmits external supply data identifying data that is included in the content data obtained by the content data obtaining section 18 to the content production and output support apparatus 14 via the data communication network 16. The external supply data receiving section 22, in response to this transmission, receives the external supply data that is returned from the content production and output support apparatus 14. The outputting section 24 outputs content such as a game, a film, and a broadcast based on the content data obtained by the content data obtaining section 18 and the external supply data received by the external supply data receiving section 22.

According to the embodiment described above, when the content production and output support apparatus 14 creates material data and script data, content data for various media can be generated therefrom, which facilitates a mutual sharing of the material data, and allows content for a plurality of different media to be promptly produced and provided. In addition, the content output apparatus 12 is supplied with a part of data that is necessary to output content as external supply data from the content production and output support apparatus 14, and the external supply data can be generated as needed using data stored in the material data storing section 30 or the script data storing section 32. Therefore, an update of material data or script data in the content production and output support apparatus 14 that is a source of external supply data can be immediately reflected in content output at the content output apparatus 12. In this way, fresh content can be output at the content output apparatus 12.

A plurality of content production and output support apparatuses may be connected via the data communication network 16, so that content can be produced by cooperation of these apparatuses. In this case, when material data is newly created or updated at each content production and output support apparatus, desirably the creation or update is quickly reported to the person in charge of the creation of other material data associated with the newly created or updated material data. In addition, when material data is newly created or updated at a content production and output support apparatus, desirably what other material data is associated with the newly created or updated material data can be known at the content production and output support apparatus.

FIG. 8 is a diagram showing an entire structure of a content providing system having a content production and output support apparatus which satisfies such needs. As shown in FIG. 8, a content providing system 10a has a plurality of content production and output support apparatuses 14a connected to the data communication network 16, which is different compared to the content providing system 10 shown in FIG. 2. Each content production and output support apparatus 14a is provided with a data update checking section 52, a person involved data creating section 50, a person involved data storing section 54, a data update reporting section 56, an updated data receiving section 58, and a dependency displaying section 60, which is different compared to the content production and output support apparatus 14 shown in FIG. 2.

In the content production and output support apparatus 14a, a creation of a new material data by the material data creating section 26 or an update of material data which has been created and stored in the material data storing section 30 is detected by the data update checking section 52. Similarly, a creation of a new script data by the script data creating section 28 or an update of script data that has been created and stored in the script data storing section 32 is detected by the data update checking section 52.

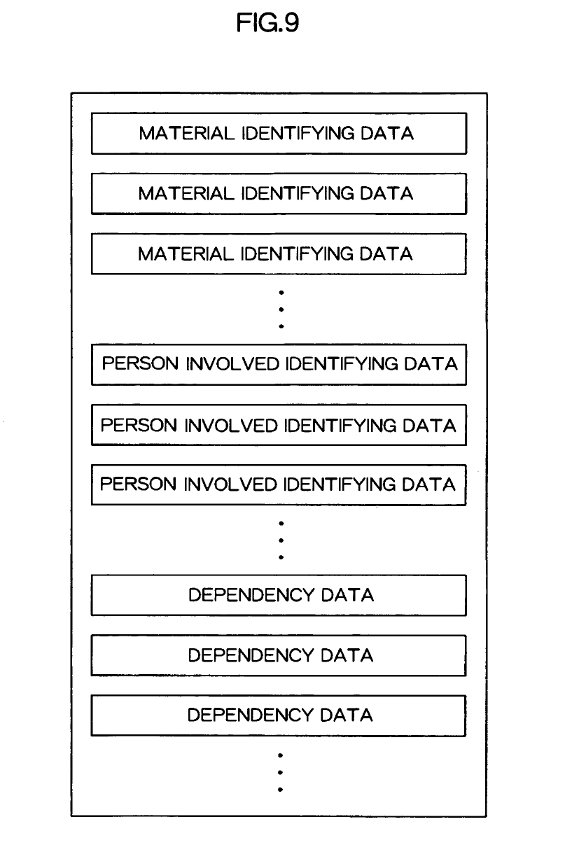

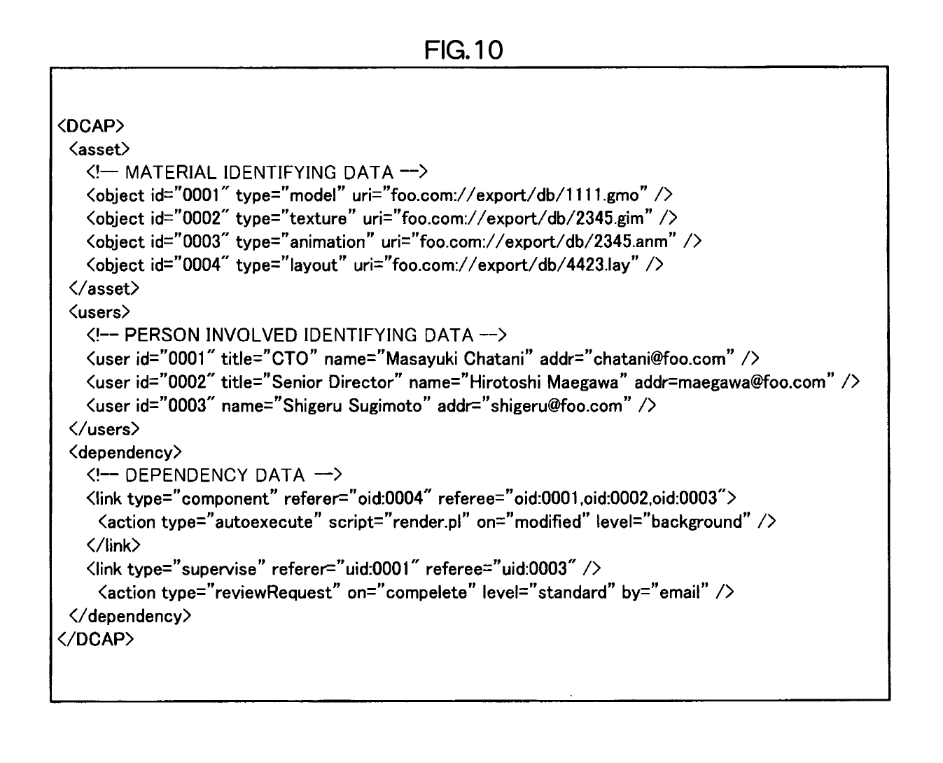

The data update checking section 52, upon detection of a new creation or an update of material data or script data, determines material data, script data, and a person which are associated with the material data or the script data (which have a dependency with the material data or the script data). Thus, the script data creating section 28, as shown in FIG. 9, creates script data that includes not only material identifying data but also person involved identifying data and dependency data, and the script data storing section 32 stores the script data having these data. FIG. 10 is a diagram showing a presentation example of a part of the script data (a part including material identify data, person involved identifying data and dependency data) in XML format.

Person involved identifying data is data (identifying information) to identify a person involved of the system. A dependency data is data which indicates a dependency between material data and another material data, a dependency between the script data and other script data, a dependency between the script data and the material data, a dependency between the material data or the script data and a person involved, and a dependency between persons involved, and specifically, includes a combination of a depending material identifying data for identifying material data, depending script identifying data for identifying script data, or depending person involved identifying data for identifying person involved data and depended material identifying data, depended script identifying data or depended person involved identifying data. The dependency data also includes data that indicates a type of dependency, and an action to be executed when an event such as a new creation or an update of depending or depended data occurs. The action may be, for example, an automatic execution of rendering, a transmission of an e-mail to other person involved, and the like. This configuration allows rendering using layout data that is identified by depending material identifying data to be executed when any change is added to model data, texture data, or animation data that is identified by depended material identifying data. Alternatively, when data that is identified by depended material identifying data is updated, an e-mail to ask for a check of the updated data can be transmitted to a person involved who is identified by depending person involved identifying data. Depending or depended dependency data may have descriptions of not only script identifying data for the script data which includes the dependency data, and material identifying data or person involved identifying data which is described in the script data, but also the script data of other script data, and material identifying data or person involved identifying data which is described in other script data.

An example of the dependency data includes a combination of depending data in which a material identifying data for motion data is set and depended data in which material identifying data for model data is set. In this case, the dependency data provides a notification to check of an update of motion data upon an update of model data. In another case where dependency data including depending data in which person involved identifying data is set and depended data in which material identifying data for model data is set is used, upon an update of model data, the update can be reported to a person involved who is identified by the person involved identifying data which is set in the depending data.

The person involved data creating section 50 creates information (person involved data) on a person involved of the content providing system 10, and has inputs of the e-mail address, a name, a business title, and the like of the person involved in relation to person involved identifying data which identifies the person involved. The person involved data storing section 54 stores person involved data that is created by the person involved data creating section 50. That is, the person involved data storing section 54 stores the e-mail address, a name, a business title, and the like of a person involved who is identified by each person involved identifying data in relation to the person involved identifying data.

When the data update checking section 52 detects a new creation or an update of material data or script data, the data update checking section 52 determines material data, script data, and a person involved which are associated with (have a dependency with) the material data or the script data, using script data (especially dependency data included therein) stored in the script data storing section 32 and person involved data stored in the person involved data storing section 54. Specifically, upon detection of a new creation or an update of material data or script data, the data update checking section 52 retrieves dependency data which includes identifying data for the material data or the script data as depending identifying data from script data, and reads out material identifying data, script identifying data, and person involved identifying data which are included in depended data of the dependency data.

Then, the data update checking section 52 gives an instruction to cause the dependency displaying section 60 to display an identification (such as a highlight) of material data or script data associated with the newly created or updated material data or script data. For example, the data update checking section 52 gives an instruction to cause the dependency displaying section 60 to display an identification of material data or script data by supplying material identifying data of the material data which should be identified or script identifying data of the script data which should be identified.

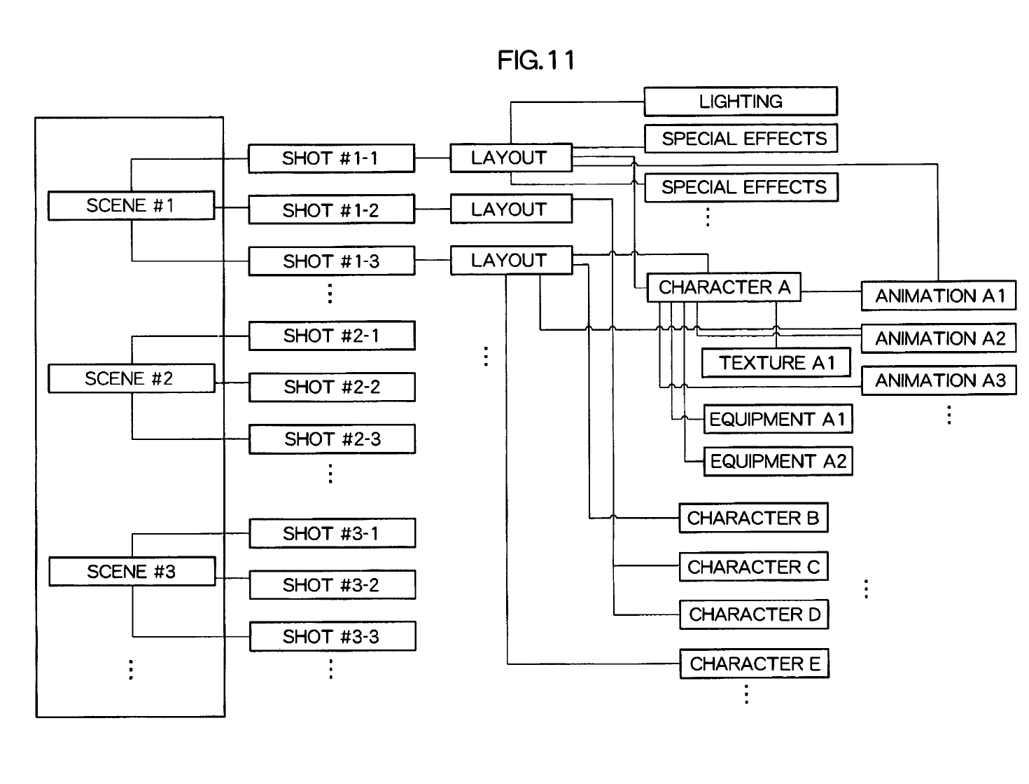

The dependency displaying section 60 outputs a tree structure which shows a dependency of material data or script data to a display device, based on script data which is stored in the script data storing section 32. FIG. 11 is a diagram showing an example of script data which is used to produce a film with three dimensional computer graphics. As shown in FIG. 11, in the film which is produced with three dimensional computer graphics, material data for presenting scenes (a semantic group of screen images), material data for presenting shots in each scene (a series of screen images without any camera switches (discontinuous changes of camera position and/or direction)), material data for presenting a layout (structure of a virtual three dimensional space) which is used in each scene, and material data for presenting lighting (e.g., a position, a color, and a moving route of a light source) which is used for each layout, special effects (e.g., sprite), a character (e.g., outlines of a character object), textures (a texture image attached to a character object), equipment (other objects which follow a character object), and animation (e.g., motion data of a character object) are used. Script data has a description about the relationship between the above data. In this example, the following data from the scenes are made up with all material data, but the scenes may be created as script data and others following the shots may be created as material data. The whole film consists of a group of scenes, each scene consists of shots, each shot consists of layouts, and each layout consists of lighting and special effects, and material data has hierarchies between these. A selection of material data and script data from the hierarchies may depend on each content production and output support apparatus 14a.

The dependency displaying section 60 displays a marker which shows material data described in script data and a marker which shows the script data on a display device, and also displays lines which show connections between the material data and the script data on the same display device. This allows a relationship between the material data and the script data to be viewed as a tree structure. Also, upon receipt of an instruction to display an identification of material data or script data which is accompanied with material identifying data or script identifying data from the data update checking section 52, the dependency displaying section 60 displays a marker in a different aspect for material data or script data identified by the material identifying data or the script identifying data. In this way, material data or script data associated with newly created or updated material data or script data can be informed to a person involved in an easily understandable way. In this example, dependency is displayed in a tree structure, but other forms including a list structure may be displayed. In addition, the dependency displaying section 60 may display a dependency between persons involved, and a dependency between data and a person involved, as well as a dependency between material data or between script data.

Upon detection of a new creation or update of material data or script data, the data update checking section 52 determines material data or script data associated with (having a dependency with) the material data or the script data, and further obtains person involved identifying data for a person involved associated with the material data or the script data from dependency data. Then the data update checking section 52 reads out the e-mail address stored in relation to the person involved identifying data from person involved data storing section 54, and transmits a report of the new creation or update of material data or script data to the e-mail address. The report is transmitted with information on the e-mail address and an identifying data for the newly created or updated material data or script data to the data update reporting section 56. Upon a receipt of the e-mail address and the material identifying data or script identifying data from the data update checking section 52, the data update reporting section 56 transmits the received material identifying data or script identifying data to the received e-mail address. Moreover, the data update checking section 52, upon a detection of a new creation or update of material data or script data, obtains person involved data of a person involved associated with the material data or the script data from dependency data, and further reads out the e-mail address stored in relation to the person involved identifying data from the person involved data storing section 54, and transmits a report about the new creation or update of material data or script data to the e-mail address. The report is also transmitted with information the e-mail address and identifying data for the newly created or updated material data or script data to the data update reporting section 56. Upon receipt of the e-mail address and the material identifying data or script identifying data from the data update checking section 52, the data update reporting section 56 transmits the received material identifying data or script identifying data to the received e-mail address. In this way, a new creation or update of material data or script data can be informed to the person involved. Instead of material identifying data or script identifying data, only identifying information such as a name of material data or script data may be transmitted.

When the data update checking section 52 detects a new creation or update of material data or script data, the data update reporting section 56 further transmits identifying data for these data to other content production and output support apparatus 14a. Such a material identifying data or script identifying data, transmitted in this way, is received by the updated data receiving section 58. The updated data receiving section 58 then reports a new creation or update of material data or script data to the data update checking section 52 at another content production and output support apparatus 14a. The data update checking section 52 gives an instruction to cause the dependency displaying section 60 to display a dependency about the newly created or updated data as in the case where material data or script data is newly created or updated at a content production and output support apparatus 14a to which a data update checking section 52 is provided.

The content data generating section 34 regenerates content data when material data or script data is newly created or updated. The regeneration may be performed immediately after the new creation or update of material data or script data, or may be performed after material data or script data associated with (having a dependency with) the material data or the script data is newly created or updated. In the latter case, desirably the data update checking section 52 monitors the timing at which to perform the regeneration. If content is regenerated totally at every time of an update of material data, the content production processing will be operated at a low efficiency. Thus, preferably, some material data are set into a group, so that when one of the material data in the group is newly created or updated, a part of the content is regenerated using the material data in the group. For example, animation data (material data), texture data (material data), model data (material data), and layout data (material data) is set to belong to one group, as a result of which, every time any change is added to one of these material data, in an arrangement presented by the layout data, a texture presented by the texture data can be mapped to a model whose outline is presented by the model data, and a procedure to generate three dimensional computer graphics can be implemented so that the model moves as presented by the animation data. In addition, the data update checking section 52 may monitor a completion of update of material data in one group, so that after a completion of update of all of the material data, the data update checking section 52 can regenerate a content data using script data that includes material identifying data for these material data. A completion of update of material data in one group may be determined by, first, a determination of creators of each material data from dependency data, and then, receipts of reports (for example, by e-mail) about completion of update from all of the creators.

According to the content providing system 10a described above, when material data or script data is newly created or updated, material data or script data which has a dependency with the material data or the script data can be immediately known by an output displayed on the dependency displaying section 60. In addition, the new creation or update of material data or script data can be immediately reported using an e-mail to the person involved with the new creation or update. In this way, content production can be effectively performed.

Other elements of the content providing system 10a are similar to those of the content providing system 10, and so will not be explained herein, and will be designated by the same reference numerals in FIG. 8. Creation and storage of script data, creation and storage of person involved data, generation of content data, and processing of external supply data do not need to be performed at all of the content production and output support apparatuses 14a. So, when a plurality of content production and output support apparatuses 14a are used, some of the apparatuses 14a do not need to be provided with sections other than the material data creating section 26, the data update checking section 52, the dependency displaying section 60, displaying device 62, the data update reporting section 56, and the updated data receiving section 58.

1. A content providing system comprising a content production apparatus and a content output apparatus that are connected in communication with each other via a data communication network,
the content production apparatus comprising:
material data creating means for creating one or a plurality of material data that individually include at least one of dynamic image data, static image data, and voice data;
material data storing means for storing the created material data;
script data creating means for creating script data including one or a plurality of material identifying data that individually identifies either one or a plurality of material data;
script data storing means for storing the created script data; and
content data generating means for generating content data in a form that corresponds to a media specified by a user based on the script data identified by the user and the material data identified by the material identifying data in the script data, and
the content output apparatus comprising:
content data obtaining means for obtaining the content data that is generated by the content data generating means; and
outputting means for outputting content in a predetermined way based on the obtained content data.

2. The content providing system according to claim 1, wherein the content data generating means comprises means for storing form data that indicates the form for content data corresponding to each medium, so that the content data generating means reads out the form data that corresponds to a medium specified by a user from the storing means to generate content data in the form presented by the form data.

3. The content providing system according to claim 1, wherein,
the content data generating means generates content data that includes external supply data identifying data for identifying external supply data,
the content production apparatus further comprises:
an external supply data identifying data receiving means for receiving the external supply data identifying data from the content output apparatus via the data communication network, and
an external supply data returning means for returning the external supply data identified by the received external supply data identifying data to the content output apparatus via the data communication network;
the content output apparatus further comprises:
an external supply data identifying data transmitting means for transmitting the external supply data identifying data in the obtained content data to the content production apparatus via the data communication network, and
an external supply data receiving means for receiving the external supply data that is returned from the content production apparatus via the data communication network, and
the outputting means outputs content in a predetermined way based on the obtained content data and the received external supply data.

4. A method for producing content, comprising:
a material data creating step for creating one or a plurality of material data that individually includes at least one of dynamic image data, static image data, and voice data;
a script data creating step for creating script data including one or a plurality of material identifying data that individually identifies either one or a plurality of material data;
a script data identifying step for identifying the script data; and
a content data generating step for generating content data in a form that corresponds to a media specified by a user based on the identified script data and the material data identified by the material identifying data in the script data.

5. The method for producing content according to claim 4, wherein,
in the script data creating step, when the script data is created, time attribute data is further created in association with the script data that indicates the date and time when the script data is created, and
in the script data-identifying step, when the time attribute data is specified, the script data identified is in association with the specified time attribute data.

6. The method for producing content according to claim 4, wherein,
in the material data creating step, when each material data is created, time attribute data that indicates the date and time when the material data is created is further created in association with the material data, and
in the content data generating step, when the time attribute data is identified, content data is generated in a predetermined form based on the identified script data and the material data in association with the given time attribute data among the material data identified by the material identifying data in the script data.

7. The method for producing content according to claim 4, wherein,
in the content data-generating step, at least one of the identified script data and the material data identified by the material identifying data in the script data is transmitted via a data communication network.

8. The method for producing content according to claim 4, wherein,
in the content data-generating step, the generated content data is transmitted via a data communication network.

9. A method for outputting content, comprising:
a content data obtaining step for obtaining content data that includes external supply data identifying data for identifying external supply data:
an external supply data receiving step for receiving the external supply data identified by the external supply data identifying data in the obtained content data via a data communication network; and
an outputting step for outputting content in a predetermined way based on the obtained content data and the received external supply data.

10. A content output supporting method, comprising:
an external supply data identifying data receiving step for receiving external supply data identifying data that is included in content data via a data communication network; and
an external supply data-returning step for returning external supply data that is identified by the received external supply data identifying data via the data communication network.

11. The content output supporting method according to claim 10, further comprising a data generating step for generating the external supply data identified by the received external supply data identifying data, based on data stored in a storing means in advance.

12. A content production apparatus, comprising:
material data storing means for storing one or a plurality of material data that individually includes at least one of dynamic image data, static image data, and voice data;
script data storing means for storing script data including one or a plurality of material identifying data that individually identifies either one or a plurality of material data; and
content data generating means for generating content data in a form that corresponds to a media specified by a user, based on the script data identified by the user and the material data identified by the material identifying data in the script data.

13. A content output apparatus, comprising:
a content data obtaining means for obtaining content data that includes external supply data identifying data for identifying external supply data;
external supply data receiving means for receiving the external supply data identified by the external supply data identifying data that is included in the obtained content data via a data communication network; and
outputting means for outputting content in a predetermined way based on the obtained content data and the received external supply data.

14. A content output supporting device, comprising:
external supply data identifying data receiving means for receiving external supply data identifying data that is included in content data via a data communication network; and
external supply data returning means for returning external supply data that is identified by the received external supply data identifying data via the data communication network.

15. A computer readable information storage medium that stores a program for enabling a computer to function as:
material data storing means for storing one or a plurality of material data that individually includes at least one of dynamic image data, static image data, and voice data;
script data storing means for storing script data including one or a plurality of material identifying data that individually identifies either one or a plurality of material data; and
content data generating means for generating content data in a form that corresponds to a media specified by a user, based on the script data identified by the user and the material data identified by the material identifying data in the script data.

16. A computer readable information storage medium that stores a program for enabling a computer to function as:
content data obtaining means for obtaining content data that includes external supply data identifying data for identifying external supply data;
external supply data receiving means for receiving the external supply data identified by the external supply data identifying data that is included in the obtained content data via a data communication network; and
outputting means for outputting content in a predetermined way based on the obtained content data and the received external supply data.

17. A computer readable information storage medium that stores a program for enabling a computer to function as:
external supply data identifying data receiving means for receiving external supply data identifying data that is included in content data via a data communication network; and
external supply data returning means for returning external supply data that is identified by the received external supply data identifying data via the data communication network.

18. The method for producing content according to claim 4, wherein,
a part or the whole of one or a plurality of material identifying data in the script data and the material identifying data for identifying other material data associated with the material data that is identified by the material identifying data are stored in dependency storing means in advance in relation to each other, and
the method for producing content further comprises:
an informing step for informing a user of the material data identified by the material identifying data that is stored in the dependency storing means in relation to the material identifying data when the material data identified by the material identifying data in the script data is newly created or updated.

19. The method for producing content according to claim 4, wherein,
a part or the whole of one or a plurality of material identifying data in the script data and the material identifying data for identifying other material data associated with the material data that is identified by the material identifying data are stored in dependency storing means in advance in relation to each other, and also the e-mail address of the person in charge of the creation of each of the material data is stored in person involved data storing means in advance, and
the method for producing content further comprises:
a step for reading out the e-mail address of the person in charge of the creation of the material data identified by the material identifying data, which is stored in the dependency storing means in relation to the material identifying data, from the person involved data storing means, and transmitting information on the new creation or update of the material identifying data in the script data to the e-mail address when the material data identified by the material identifying data in the script data is newly created or updated.

20. A method for producing content, comprising:
a material data creating step for creating one or a plurality of material data that individually includes at least one of dynamic image data, static image data, and voice data;
a script data creating step for creating script data including one or a plurality of material identifying data that individually identifies either one or a plurality of material;
a script data identifying step for identifying the script data; and
a content data generating step for generating content data based on the identified script data and the material data that is identified by the material identifying data in the script data,
with a part or the whole of one or a plurality of material identifying data in the script data and the material identifying data for identifying other material data associated with the material data that is identified by the material identifying data being stored in dependency storing means in advance in relation to each other, and
the method for producing content further comprises:
an informing step for informing a user of the material data identified by the material identifying data that is stored in the dependency storing means in relation to the material identifying data when the material data identified by the material identifying data in the script data is newly created or updated.

21. A method for producing content, comprising:
a material data creating step for creating one or a plurality of material data that individually includes at least one of dynamic image data, static image data, and voice data;
a script data creating step for creating script data including one or a plurality of material identifying data that individually identifies either one or a plurality of material;
a script data identifying step for identifying the script data; and
a content data generating step for generating content data based on the identified script data and the material data that is identified by the material identifying data in the script data,
with a part or the whole of one or a plurality of material identifying data in the script data and the material identifying data for identifying other material data associated with the material data that is identified by the material identifying data being stored in a dependency storing means in advance in relation to each other, and also the e-mail address of the person in charge of the creation of each of the material data being stored in a person involved data storing means in advance, and
the method for producing content further comprises:
a step for reading out the e-mail address of the person in charge of the creation of the material data identified by the material identifying data, which is stored in the dependency storing means in relation to the material identifying data, from the person involved data storing means, and transmitting information on the new creation or update of the material identifying data in the script data to the e-mail address when the material data identified by the material identifying data in the script data is newly created or updated.

22. A content production apparatus used in a system which uses one or a plurality of material data that individually includes at least one of dynamic image data, static image data, and voice data, and script data including one or a plurality of material identifying data that individually identifies either one or a plurality of material, the content production apparatus comprising:
dependency storing means for storing a part or the whole of one or a plurality of material identifying data in the script data and the material identifying data for identifying other material data associated with the material data that is identified by the material identifying data in relation to each other; and
means for informing a user of the material data identified by the material identifying data that is stored in the dependency storing means in relation to the material identifying data when the material data identified by the material identifying data in the script data is newly created or updated.

23. A content production apparatus used in a system that uses one or a plurality of material data that individually includes at least one of dynamic image data, static image data, and voice data, and script data including one or a plurality of material identifying data that individually identifies either one or a plurality of material, the content production apparatus comprising:
dependency storing means for storing a part or the whole of one or a plurality of material identifying data in the script data and the material identifying data for identifying other material data associated with the material data that is identified by the material identifying data in relation to each other;
person involved data storing means for storing the e-mail address of the person in charge of the creation of each of the material data; and
means for reading out the e-mail address of the person in charge of the creation of the material data identified by the material identifying data, which is stored in the dependency storing means in relation to the material identifying data, from the person involved data storing means, and transmitting information on the new creation or update of the material identifying data in the script data to the e-mail address when the material data identified by the material identifying data in the script data is newly created or updated.

24. A computer readable information storage medium that stores a program for enabling a computer to function as a content production apparatus used in a system that uses one or a plurality of material data that individually includes at least one of dynamic image data, static image data, and voice data, and script data including one or a plurality of material identifying data that individually identifies either one or a plurality of material, the program enabling a computer to function as:
dependency storing means for storing a part or the whole of one or a plurality of material identifying data in the script data and the material identifying data for identifying other material data associated with the material data that is identified by the material identifying data in relation to each other; and
means for informing a user of the material data identified by the material identifying data that is stored in the dependency storing means in relation to the material identifying data when the material data identified by the material identifying data in the script data is newly created or updated.

25. A computer readable information storage medium that stores a program for enabling a computer to function as a content production apparatus used in a system that uses one or a plurality of material data that individually includes at least one of dynamic image data, static image data, and voice data, and script data including one or a plurality of material identifying data that individually identifies either one or a plurality of material, the program enabling a computer to function as:
dependency storing means for storing a part or the whole of one or a plurality of material identifying data in the script data and the material identifying data for identifying other material data associated with the material data that is identified by the material identifying data in relation to each other;
person involved data storing means for storing the e-mail address of the person in charge of the creation of each of the material data; and
means for reading out the e-mail address of the person in charge of the creation of the material data identified by the material identifying data, which is stored in the dependency storing means in relation to the material identifying data, from the person involved data storing means, and transmitting information on the new creation or update of the material identifying data in the script data to the e-mail address when the material data identified by the material identifying data in the script data is newly created or updated.
